(19) United States
(12) Patent Application Publication
(10) Pub. No.: US 2006/0064561 A1
(43) Pub. Date: Mar. 23, 2006

(54) Method and apparatus for operating a memory controller

(76) Inventors: Brad Simeral, San Francisco, CA (US); Chin Shih, Saratoga, CA (US); David Reed, Saratoga, CA (US)

Correspondence Address: BERKELEY LAW & TECHNOLOGY GROUP, 1700NW 167TH PLACE, SUITE 240, BEAVERTON, OR, 97006, US

(21) Appl. No.: 10/945,781

(22) Filed: Sep. 20, 2004

(51) Int. Cl. G06F 12/16

(52) U.S. Cl. 711/168; 711/162

(57) ABSTRACT

Embodiments of methods and apparatuses of operating a memory controller are disclosed.

### BACKGROUND

As the operating speed of a computing system increases, the busses providing access to one or more memory devices may become overburdened, and may not be capable of exchanging data at a rate equivalent to the rate at which data is requested by a computing system, for example. In response, additional data paths may be provided to a memory device, in order to reduce or eliminate data bottlenecks, for example. Furthermore, in operation, multiple address paths may, as part of the data exchange process, send and/or receive identical and/or redundant data bits at substantially the same time. This may result, for example, in noise and/or aggression affects on one or more components coupled to the memory device, such as one or more components of a computing system, for example. For example, close routing of traces or wires on a printed circuit board, in particular for addressing, may result in such noise. As a result, techniques for reducing and/or eliminating these undesirable effects continue to be desired.

### BRIEF DESCRIPTION OF THE DRAWINGS

Subject matter is particularly pointed out and distinctly claimed in the concluding portion of the specification. The claimed subject matter, however, both as to organization and method of operation, together with objects, features, and advantages thereof, may best be understood by reference of the following detailed description when read with the accompanying drawings in which:

FIG. 1 is a schematic diagram illustrating an embodiment of a computing system;

FIGS. 2a and 2b are schematic diagrams illustrating two embodiments of a memory controller and memory devices;

FIG. 3 is a flowchart illustrating an embodiment of a method of operating a memory controller; and

FIG. 4 is a schematic diagram of an embodiment of a portion of a memory controller.

### DETAILED DESCRIPTION

In the following detailed description, numerous specific details are set forth to provide a thorough understanding of the claimed subject matter. However, it will be understood by those skilled in the art that the claimed subject matter may be practiced without these specific details. In other instances, well-known methods, procedures, components and/or circuits have not been described in detail so as not to obscure the claimed subject matter.

As previously suggested, a computing system may comprise one or more devices, such as one or more memory devices. One or more memory devices may comprise one or more portions, which may be referred to as partitions, in at least one embodiment. Additionally, one or more memory devices may be coupled to one or more memory interfaces, and, in at least one embodiment, a memory interface may provide a path to transmit and/or receive electrical data, which may also be referred to as a signal, for example, and may comprise one or more electrical ‘1’ and/or ‘0’ bits, for example, such as in the form of data bits, for example, which may also be referred to as a signal. In this context, sending and/or receiving data between two or more devices and/or components may additionally be referred to as exchanging. Electrical data may, for example, be sent to and/or from a memory device, such as a particular memory location, designated by an address, in the memory device, for example, and one or more of the sending and/or receiving operations may be at least partially controlled by a memory controller, for example. Additionally, electrical data may be stored in one or more locations in a memory device, and the data may have a particular address, for example. One or more of the described components, such as the memory device and/or memory interface, may be at least partially controlled by a memory controller, which may be capable of controlling one or more of the functions of one or more of these components, such as controlling the rate and/or timing of data exchanges, for example.

Although numerous types and/or categories of memory devices exist, and the claimed subject matter is not limited in this respect, one or more types of memory devices may include Random Access Memory (RAM) such as one or more types of Dynamic Random Access Memory (DRAM), including Synchronous Dynamic Random Access Memory (SDRAM), Dual Data Rate memory (DDR) or Dual Data Rate second generation (DDRII), for example. The DDR and DDRII specifications have been defined by JEDEC Solid State Technology Association. DDR is defined in the JEDEC specification JESD79C, adopted in September, 2003, and DDRII is defined in the JEDEC specification JESD79-2. Details regarding these specifications may be obtained from JEDEC Solid State Technology Association, 2500 Wilson Boulevard, Alexandria, Va. Additionally, more information may be obtained from the JEDEC website at the following URL: http://www.iedec.org. As is well known, memory devices such as these are typically formed from memory cell technology, and may comprise one or more Complementary Metal-Oxide-Semiconductor (CMOS) transistor switches that may be coupled to a storage capacitor, for example. Additionally, memory devices such as these may be packaged in particular configurations, and may be packaged to be suitable for use in a computing system, for example, such as by partitioning one or more portions of memory into memory banks, which may comprise interleaved data access, for example. In one particular embodiment, one or more DRAM devices may be coupled in a Dual In-Line Memory Module (DIMM) configuration, and may, when packaged with one or more other components on a Printed Circuit Board (PCB), for example, be referred to as a chipset, for example. However, although specific types and/or categories of memory devices are explained above, it is desirable to note that the claimed subject matter is not so limited. For example, any type and/or category of memory may implement at least one of the following embodiments, and the claimed subject matter is not limited to implementation in a computing system, and/or in a memory device having one of the described configurations.

Computing systems, such as those that may be capable of implementing one or more of the foregoing memory devices, may comprise one or more of the following, although these examples are provided for reference, and are not intended to cover all computing systems that may be utilized in accordance with one or more of the claimed embodiments. For example, computers, including desktop computers, laptop computers, servers, switches, and/or hubs, handheld devices, including digital cameras and/or cellular telephones, and may additionally include peripheral devices, including printers, monitors, and/or scanners, for example. Those skilled in the art will recognize, however, that the claimed subject matter is again not limited to these particular examples. Additionally, although the claimed subject matter is again not limited in this respect, one or more of the computing systems as described above may implement one or more components in addition to the memory devices, as described previously. For example, one or more of the aforementioned computing systems may implement one or more integrated circuit (IC) components, such as one or more microprocessors, graphics processing units (GPUs), digital signal processors (DSPs), one or more memory devices, one or more application specific integrated circuits (ASICs), and may include other types of electronic components, such as capacitors, resistors, and/or connectors, including input/output (I/O) connectors for coupling to external circuitry, such as bus circuitry, for example. Of course, these are simply examples and the claimed subject matter is not limited in scope to these examples.

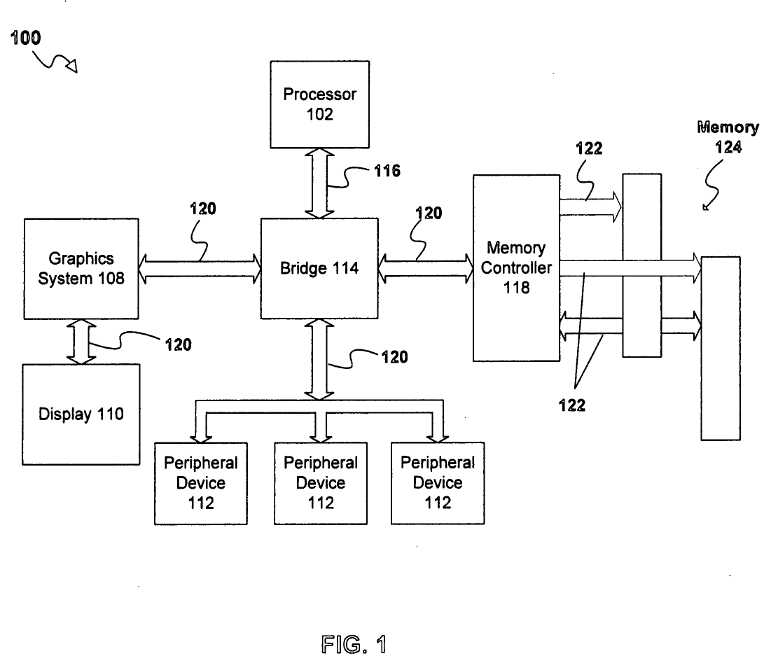

As indicated above, a computing device may utilize one or more memory devices, and may additionally comprise one or more additional devices. Referring now to FIG. 1, there is illustrated a block diagram of one embodiment of a computing system having a particular architecture, in accordance with at least one embodiment of the claimed subject matter. Illustrated in FIG. 1 is a computing system 100. Likewise, it may comprise one or more of the computing systems, as described previously. In this embodiment, a computing system 100 is illustrated, which comprises the following devices, illustrated as discrete blocks for sake of brevity, but it is desirable to note that one or more of the illustrated components may comprise one or more physically and/or functionally distinct devices, or may be physically and/or functionally integrated, for example. System 100 may comprise, for example: a bridge 114, which may provide particular functionality for system 100, including routing and/or switching of data between one or more of the following devices; a processor 102, which may comprise a central processing unit (CPU), for example, and may be coupled to bridge 114 by use of a bus 116, which may comprise a front side bus (FSB) 116; a graphics system 108 coupled to bridge 114, which may comprise one or more additional devices (not shown) such as one or more memory devices, and one or more graphics processing units (GPU), and which may be coupled to bridge 114 by use of a data path 120, which may comprise one or more types of busses, for example; a display 110, which may comprise a monitor, for example, and may be coupled to graphics system 108 by use of a data path 120; one or more peripheral components 112, which may comprise one or more types of peripheral devices including one or more peripheral device interfaces and/or graphics system interfaces, and which may be coupled to bridge 114 by use of one or more data paths 120; a memory controller 118 coupled to bridge 114 by use of one or more data paths 120, and one or more memory devices 124 coupled to memory controller 118, which may comprise one or more types of memory devices, and which may be coupled to memory controller 118 by use of one or more data paths 122. However, it is desirable to note that the claimed subject matter is not so limited, and multiple variations and/or additions may be made to the illustrated devices, and remain in accordance with at least one embodiment.

In at least one embodiment, in operation, electronic data, such as one or more ‘1’ and/or ‘0’ bits may be exchanged between one or more of the illustrated devices. In one embodiment, processor 102 may request access to data stored in memory 124, also referred to as a memory request. Additionally, memory 124 may have data stored in one or more particular locations in memory, such as one or more data locations, for example. Processor 102 may request data at a particular location, such as by providing one or more signals to bridge 114 by use of FSB 116, and at least a portion of the signal may be provided to memory controller 118, such as by a data path including one or more data paths 122, for example. In response to the memory request, memory controller 118 may perform particular operations in response to the one or more electrical signals, including determining a particular location or locations where the requested electronic data is stored in memory 124, for example, and/or retrieving at least a portion of the requested data, such as by utilizing one or more data paths 122, which may depend on the particular location(s) of where one or more of the portions of requested electronic data may be stored, for example. These data paths include paths to indicate the particular address of a memory location being written to or being read from. However, again, this is just one example of an operation that may be performed by one or more of the illustrated devices, and the claimed subject matter is not limited in this respect.

As alluded to previously, one or more data paths, such as data paths 122, for example may exchange similar data, such as at substantially the same time, which may result in undesirable effects, such as noise and/or aggression affects, for example. One particular type of data exchange may be referred to as a Simultaneous Switching Operation (SSO), which may comprise sending substantially the same data to a plurality of memory devices and/or portions, for example. Although the claimed subject matter is not limited in scope in this respect, one reason for sending the same or substantially the same data to more than one memory device is to provide the capability to access data more quickly, as explained in more detail later. However, a disadvantage of this approach, as previously suggested, is the potential for electrical interference or other sources of noise. This may occur, for example, in a situation in which multiple data paths are transmitting substantially the same address data to different memory devices, for example.

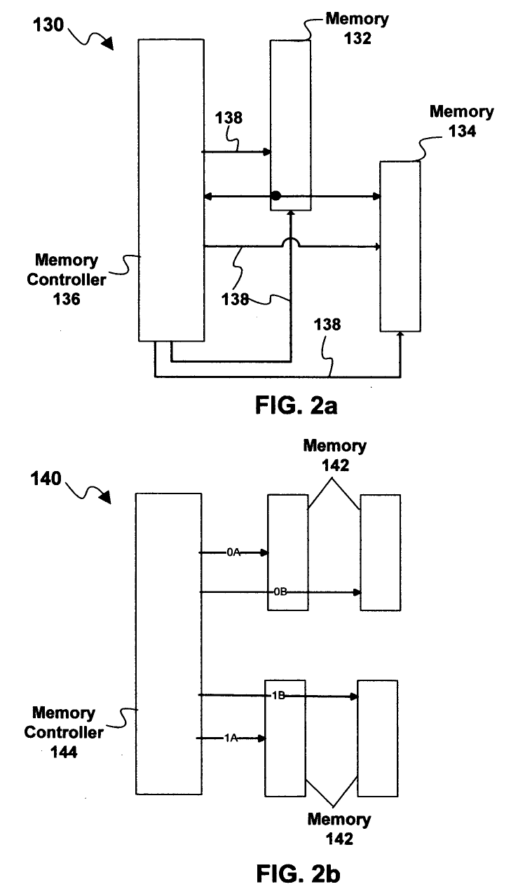

Referring now to FIG. 2a, there is illustrated a memory controller and memory device, which may comprise part of a computing system, such as system 100 of FIG. 1, although the claimed subject mater is not so limited. Illustrated in FIG. 2a is memory controller 136. Although not illustrated in detail, memory controller 136 may comprise the following components, such as one or more processors, such as a CPU, one or more input/output (I/O) interfaces, and/or one or more components capable of performing functions including timing, caching, pre-fetching and/or precharge, as just a few examples. It is desirable to note, however, that alterations and/or variations may be made to the illustrated and/or described components while still remaining within the scope of the claimed subject matter. Additionally, memory controller 136 may be coupled to a plurality of memory devices, such as 132 and 134, and may be coupled by data paths 138, for example, which may comprise busses, including address busses, although the claimed subject matter is not so limited.

Additionally, as illustrated in FIG. 2b, a memory controller may be coupled to more than two memory devices and/or portions. Similar to FIG. 2a, memory controller 144 and/or memory 142 may comprise part of a computing system such as system 100 of FIG. 1, although the claimed subject mater is not so limited. Additionally, although not illustrated in detail, memory controller 144 may comprise a variety of components, such as those discussed above. Memory controller 144, in this embodiment, is coupled to memory 142, which, in this embodiment, comprises 4 memory portions, which may comprise separate memory devices, or may comprise four portions of a single device, such as four partitions of memory, as just a few examples. Here, memory controller 144 has a data path to the memory devices, illustrated as 0A, 0B, 1A and 1B, although the claimed subject matter is not so limited. Likewise, in this particular embodiment, these paths provide address data to the respective memory devices. In at least one embodiment, one or more data paths, and, therefore, one or more memory portions, may be at least partially redundant, such as paths 0A and 0B, and/or paths 1A and 1B, for example, or, alternatively, paths 0A and 1B, and paths 1A and 0B may be redundant, for example. Such redundancy may be provided for a variety of reasons and the scope of the claimed subject matter is not limited to a particular situation in which components or other hardware portions may be redundant. However, as suggested previously, faster transfer of data may possible in systems that employ such redundancy, for example.

In operation, memory controller 136 and/or 144 may exchange data with one or more memory devices, such as devices 132, 134 and/or 142, respectively, in the following manner: a request, such as a memory request, may be received by a memory controller, and may comprise a request to read and/or write data to and/or from one or more portions memory. The request may be made by a component of a computing system (not shown), such as one or more of the components of computing system 100 of FIG. 1, for example, and may be provided to the memory controller by a memory interface, and provided by a bridge, such as bridge 114 of FIG. 1, for example. Memory controller may, in response to a request, perform one or more reading and/or writing operations, such as by accessing one or more portions of one or more of the memory devices, and reading and/or writing data to the particular one or more portions, for example. In this particular configuration, such as in the aforementioned SSO, where a plurality of memory devices may be coupled to a memory controller, the memory controller may send and/or receive similar electronic data along a plurality of data paths, such as by sending similar electronic data along data paths 0A and 0B, and/or 0A and 1B, for example, such as at substantially the same time. In this example, these lines are address lines to the respective devices. For example, an electrical ‘1’ may be provided along data paths 0A and 0B and/or 0A and 1B at substantially the same time, and may comprise a redundant operation, if, for example, memory 142 is configured as redundant memory banks or portions, for example. As also alluded to previously, transmitting substantially the same electrical data at substantially the same time may result in one or more undesirable effects, including electrical interference and/or noise, for example. In this context, noise may comprise electrical activity present in addition to a signal comprising data, for example, and may be a result of one or more physical properties of a system, for example, although the claimed subject matter is not so limited.

In order to reduce and/or eliminate one or more of these undesirable effects, such as noise and/or aggression affects, one or more portions of data may be altered and/or substituted prior to sending and/or receiving from one or more of the devices of FIG. 2a or 2b, such as to and/or from memory controllers 136 and/or 144, one or more of the memory devices 132, 134 and/or 142, to an/or from devices 118 and/or 124 of FIG. 1, for example. In one particular embodiment, one or more electrical bits of data, such as an electrical ‘1’ and/or ‘0’, may be altered, such as switched and/or toggled to the opposite data signal value, for example. Additionally, electrical data may be substituted for the transmitted data, such as by substituting an electrical ‘0’ for data transmitted. For example, electrical data, such as an electrical ‘1’ may be provided along data path 0A, and the data may be modified, and transmitted along another path such as 0B and/or 1B, at substantially the same time. In this embodiment, modifying may comprise holding previous data, which may comprise transmitting substantially the same data provided during a previous transmit operation, toggling at least a portion of the data, and/or providing an electrical ‘0’, for example, although the claimed subject matter is not so limited. Providing redundant data to differing memory portions, wherein at least a portion of the data is modified, such as by providing data along data paths 0A and 1B, wherein the data provided along data path 0A or 1B is modified, may result in the capability to provide groups of signals, such as ganged signals, and reduce or eliminate one or more of the aforementioned undesirable affects, such as noise and/or aggression affects, for example. However, particular modification operations may be better understood as explained in more detail hereinafter.

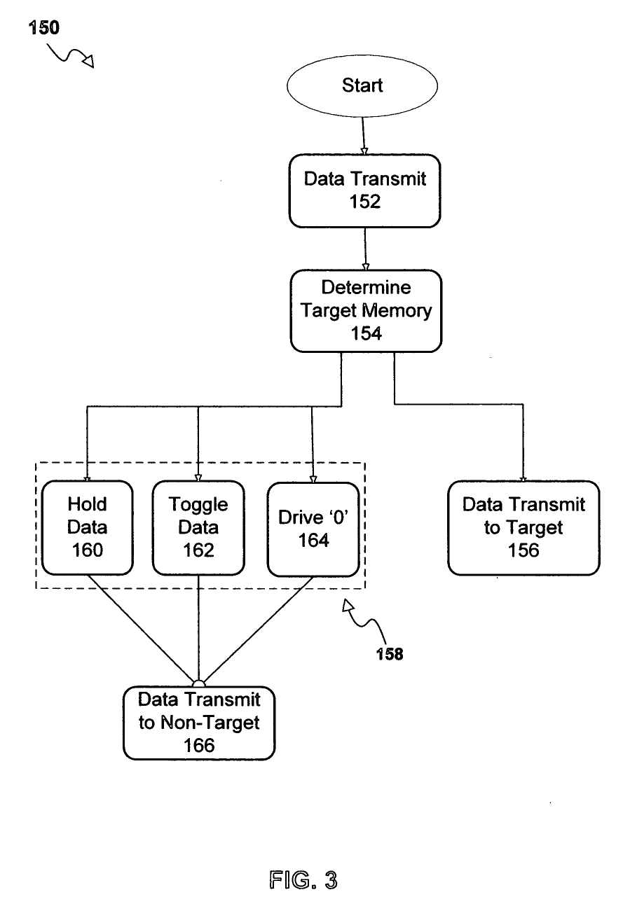

One or more of the previously-described operations may be better understood with reference to FIGS. 3 and/or 4. Referring now to FIG. 3, one embodiment of a method of operating a memory controller is illustrated by a flowchart, although, of course, the claimed subject matter is not limited in scope in this respect. Such an embodiment may be employed to at least partially operate a memory controller, as described below. The flowchart illustrated in FIG. 3 may be implemented in a device at least in part, such as device 100 of FIG. 1, and/or device 130 of FIG. 2a, and/or device 140 of FIG. 2b, for example, although the claimed subject matter is not limited in this respect. The order in which the blocks are presented may not limit the claimed subject matter to any particular order. Likewise, intervening additional operations and/or processes not shown by intervening blocks may be employed without departing from the scope of the claimed subject matter.

Flowchart 150 depicted in FIG. 3 may, in alternative embodiments, be implemented in software, hardware and/or firmware, such as by system 100 of FIG. 1, for example, and may comprise discrete and/or continual operations. In this embodiment, at block 152, data, such as electrical data, may be transmitted to a memory controller, such as memory controllers 136 and/or 144 of FIGS. 2a and 2b, for example, and the data may comprise one or more electrical data bits, for example. The electrical data may be designated to be provided to one or more portions of a memory device, and a determination may be made, at block 154, regarding the particular portion or portions of memory the data may be designated to be transmitted to, and the particular portion or portions of memory may be referred to as the target memory. At block 156, the data transmitted at block 152 may be provided to the target memory. Additionally, one or more alterations and/or substitutions of the data may be provided to one or more portions of memory not comprising the target memory, at block 158. One or more of the functions of block 158 may be performed, such as one or more substitutions and/or alterations, as explained in more detail below, by one or more of the aforementioned memory controllers, for example, and this may result in a reduction and/or elimination of one or more undesirable affects, such as noise and/or aggression affects that may be produced during the data exchange process of a memory controller and one or more memory devices, for example. Briefly, however, for this embodiment, data, such as data provided to the one or more portions of non-target memory may be: (1) held, and/or provided again (at block 160); (2) toggled (at block 162); and/or provided as electrical ‘0’ (at block 164). It is noted, however, for this embodiment, that while one or more of the functions may be performed, and one or more signals may be provided to the non-target memory at block 166, likewise, the unaltered or un-substituted data may be provided substantially simultaneously to target memory.

In this embodiment, at block 152, data may be transmitted. As mentioned previously, data may be transmitted from a device or one or more components of a device, such as one or more of the devices of system 100, for example. The data may be transmitted from one or more devices and/or locations, for example, and may be transmitted by use of one or more data paths and/or switches, for example. The data, in at least one embodiment, may comprise a memory request, and the request may comprise a request to access data stored in one or more locations of one or more memory devices, and/or may comprise a request to write data to one or more locations of one or more memory devices, or a combination thereof, for example. However, it is desirable to note that the claimed subject matter is not so limited, and any data transmitted to a memory controller and/or memory device may incorporate at least one embodiment of the claimed subject matter.

In this embodiment, at block 154, a target memory may be determined, and the determination may be based at least in part on the data transmitted at block 152, such as by reading at least a portion of the data, for example. Determination of target memory may be performed by one or more portions of a memory controller, for example, such as memory controller 136 of FIG. 2a, for example. In at least one embodiment, a plurality of memory devices and/or a plurality of memory portions of one or more memory devices, such as one or more memory addresses in one or more partitions, for example, may be targeted by at least one portion of data transmitted at block 152, for example. At block 156, at least a portion of the data may be transmitted to the target memory as determined at block 154, for example. As mentioned previously, this may comprise transmitting data to one or more portions of one or more memory devices, for example. Additionally, one or more portions of data transmitted to the target memory at block 156 may be provided to block 158.

In this embodiment, at block 158, one or more portions of the data transmitted at block 152 and provided by block 154 may be altered and/or substituted, for example, which may result in the reduction and/or elimination of one or more undesirable affects, such as noise and/or aggression affects, for example. One or more of the functions of one or more of the blocks 160, 162 and/or 164 may perform one or more operations, and may provide data to block 166. In one embodiment, block 160 may substitute at least a portion of the provided data, such as by holding the data provided in a previous operation, such as in the last operation, for example. In this embodiment, holding, as used in this context, may comprise sending substantially similar data as was sent in a previous data transfer operation, for example. In another embodiment, at block 162, at least a portion of the data provided by block 154 may be toggled, such as by inverting at least a portion of the data, for example. In yet another embodiment, block 164 may substitute at least a portion of the provided data, such as by providing one or more electrical ‘0’ bits as a substitute for at least a portion of the data, for example. One or more of the blocks 160, 162 and/or 164 may transmit data to one or more portions of non-target memory, for example. As mentioned previously, this may reduce and/or eliminate noise and/or aggression affects from a device and/or system implementing one or more of the functions of flowchart 150, such as device 100 of FIG. 1, and/or device 130 of FIG. 2a, and/or device 140 of FIG. 2b, for example, although the claimed subject matter is not limited in this respect.

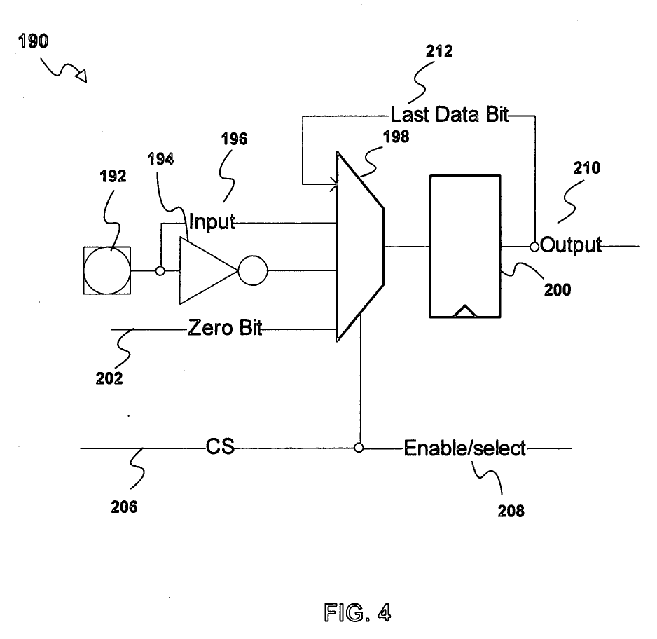

One or more of the operations of one or more of the blocks 160, 162 and/or 164 may be better understood with reference to FIG. 4. Illustrated in FIG. 4 is a schematic diagram of a circuit 190 implementing one or more of the functions of flowchart 150, such as one or more of the functions of block 158, for example. Illustrated in FIG. 4 are the following components, although it is desirable to note that additional and/or substitute components may be utilized in alternative embodiments to perform one or more of these functions: an inverter 194; a multiplexer 198; and a flip-flop 200. Additionally, a plurality of data paths 196, 202, 206, 208, 210 and 212 may be configured to provide data paths between one or more of the aforementioned components, and/or may provide input and/or output functionality, such as between one or more components of a computing system, such as between a component and a memory device of system 100 of FIG. 1, for example, although the claimed subject matter is not so limited. One or more of the components of circuit 190 may be implemented in a memory controller. For example, although the scope of the claimed subject matter is not limited in this respect, such a circuit may be provided for respective data paths to target and non-target memory. In such an embodiment, therefore, bits transmitted may be handled separately regarding the particular operation performed with respect to the data transmitted to non-target memory. Likewise, for this particular embodiment, as previously indicated, data bits transmitted to non-target memory via first data path are redundant with data bits transmitted to target memory via a second data path.

In operation, data, such as electrical data, may be provided from a memory location designated 192, and may be provided to inverter 194 and/or multiplexer 198. Again, this particular path in this particular embodiment is redundant. In this embodiment, data provided by 192 may be provided to inverter 194, and may additionally be provided to multiplexer 198 along input data path 196. Additionally, in this embodiment, at least a portion of the data provided to the inverter 194 may be inverted, and the inverted data may be provided to multiplexer 198. Likewise, an electrical ‘0’ may be provided to the multiplexer along zero bit data path 202, for example. Additionally, data may be provided to multiplexer 198 by last data bit data path 212, and may comprise the last data provided in a previous operation, as explained previously. Data may be provided Enable/Select data path 208, and, in at least one embodiment, the data may comprise data instructing the multiplexer those signals to provide to flip-flop 200, for example. Thus, multiplexer 198 may provide one or more portions of data provided in one or more of the aforementioned operations to flip-flop 200. Flip-flop 200 may provide at least a portion of the data as an output signal along path 210, for example, and the particular portion of data provided may depend at least in part on the data provided from Enable/Select data path 208, for example. At least a portion of the data provided by multiplexer 198 may be provided along data path 212 as an input signal to multiplexer 198, and may be used in a subsequent operation, for example. One or more of the aforementioned functions may be performed again for subsequent data, for example. In one embodiment, wherein two or more memory portions may be implemented in a computing system, redundant data may be provided to 192. In this embodiment, CS data path 206 may provide data for each of the hardware systems, indicating that at least one set of data is redundant, and at least one set of data is not redundant. Additionally, Enable/Select data path 208 may provide data including data indicating whether multiplexer 198 should provide inverted data, substituted data, and/or the data provided to 192. In this embodiment, as previously suggested, one portion of memory may receive data provided to 192, and one or more other portions of memory may receive altered and/or substituted data substantially simultaneously, for example.

Additionally, in one particular embodiment, a system, such as system 100 of FIG. 1, may incorporate one or more of the components of device 190 of FIG. 4, such as by implementing one or more of the components in memory controller 118 of FIG. 1, for example. In one embodiment, at least a portion of device 190 may be coupled to memory data paths, such as data paths 122 of FIG. 1, data paths 138 of FIG. 2a, and/or Data paths 0A, 0B, 1A and/or 1B of FIG. 2b, for example. In this embodiment, referring to FIG. 1, a device, such as processor 102, may transmit data to memory controller 118, such as by use of bridge 114 and/or data paths 116 and/or 120, for example. In at least one embodiment, the transmitted data may comprise a memory request, such as a request to read data to and/or write data from a particular memory location, such as one or more portions of memory 124, for example. The data may be provided to memory controller 118, which may include circuit 190, as previously suggested. Depending at least in part on one or more signals provided from data paths 208, for example, the multiplexer may provide particular data to flip-flop 200, such as the data as provided from device 192, inverted data provided from inverter 194, and/or one or more portions of data provided from data paths 202 and/or 212, for example. For example, data path 208 may provide data for a redundant data path. In this case, for this embodiment, for example, at least a portion of the data may be inverted and/or substituted, such as by previous data and/or an electrical ‘0’, for example. Conversely, if the data is not redundant data, the data provided by input data path 196 may be provided as the output signal, for example. Although, of course, these are just a few examples, and the claimed subject matter is not limited in this respect. As mentioned previously, this may reduce and/or eliminate noise and/or aggression affects from a device and/or system implementing one or more of the functions of circuit 190, such as device 100 of FIG. 1, and/or device 130 of FIG. 2a, and/or device 140 of FIG. 2b, for example, although the claimed subject matter is not limited in this respect.

It will, of course, also be understood that, although particular embodiments have just been described, the claimed subject matter is not limited in scope to a particular embodiment or implementation. In the preceding description, various aspects of the claimed subject matter have been described. For purposes of explanation, specific numbers, systems and/or configurations were set forth to provide a thorough understanding of the claimed subject matter. However, it should be apparent to one skilled in the art having the benefit of this disclosure that the claimed subject matter may be practiced without the specific details. In other instances, well-known features were omitted and/or simplified so as not to obscure the claimed subject matter. While certain features have been illustrated and/or described herein, many modifications, substitutions, changes and/or equivalents will now occur to those skilled in the art. It is, therefore, to be understood that the appended claims are intended to cover all such modifications and/or changes as fall within the true spirit of the claimed subject matter.

1. A method, comprising:
transmitting data substantially simultaneously to one or more memory locations of two or more memory portions along two or more data paths, wherein at least one of said two or more data paths to at least one of said two or more memory portions is redundant; and
modifying the data transmitted along the at least one redundant data path.

2. The method of claim 1, wherein said data comprises one or more electrical bits of data.

3. The method of claim 1, wherein at least one of said two or more data paths are coupled to a computing device.

4. The method of claim 2, wherein said modifying the data further comprises altering, switching, or toggling at least a portion of said data.

5. The method of claim 4, wherein at least one of said altering, switching, and/or toggling comprises substituting at least a portion of said data with an electrical zero.

6. The method of claim 4, wherein at least one of said altering, switching, and/or toggling comprises inverting at least a portion of said data.

7. The method of claim 1, wherein said modifying comprises transmitting substantially the same data transmitted during a previous transmitting operation.

8. The method of claim 1, wherein said two or more memory portions comprise partitions of a single memory device.

9. The method of claim 8, wherein said memory device comprises one or more of: Dynamic Random Access Memory (DRAM), Synchronous Dynamic Random Access Memory (SDRAM), and/or Dual Data Rate memory (DDR), (DDRII).

10. The method of claim 1, wherein at least one of said two or more data paths comprise address busses.

11. An apparatus, comprising:
two or more data paths, wherein at least one of said two or more data paths is redundant, and said two or more data paths respectively comprise an inverter, a multiplexer coupled to said inverter, and a flip-flop coupled to said multiplexer;
wherein said inverter, multiplexer, and flip-flop comprising said at least one redundant data path are configured to, in operation, receive data transmitted substantially simultaneously to one or more memory locations of two or more memory portions along said two or more data paths, and modify the data transmitted along the at least one redundant data path.

12. The apparatus of claim 11, wherein said inverter, multiplexer, and flip-flop comprising at least one of said two or more data paths further comprise a memory controller.

13. The apparatus of claim 11, wherein modifying the data further comprises altering, switching, and/or toggling at least a portion of said data, and providing at least a portion of said altered, switched, and/or toggled data to a memory device.

14. The apparatus of claim 13, wherein at least one of said altering, switching, and/or toggling further comprises inverting at least a portion of one or more data bits by said inverter.

15. The apparatus of claim 13, wherein at least one of said altering, switching, and/or toggling further comprises substituting at least a portion of said data with an electrical zero, wherein said substituting is substantially performed by said multiplexer.

16. The apparatus of claim 11, wherein modifying the data comprises transmitting substantially the same data transmitted during a previous transmitting operation.

17. The apparatus of claim 11, wherein said memory device comprises one or more of: Dynamic Random Access Memory (DRAM), Synchronous Dynamic Random Access Memory (SDRAM), and/or Dual Data Rate memory (DDR), (DDRII).

18. A computing system, comprising:
one or more memory devices, wherein at least one of said one or more memory devices comprises two or more memory portions;
one or more memory controllers coupled to at least one of said one or more memory devices; and
one or more data paths coupled respectively to at least two of said two or more memory portions, wherein at least one of said one or more data paths are redundant;
said memory controller being configured to, in operation, receive data transmitted substantially simultaneously to said two or more memory portions along said one or more data paths, and modify the data transmitted along the at least one redundant data path.

19. The computing system of claim 18, wherein said computing system further comprises: a processor, a bridge coupled to the processor, one or more graphics systems coupled to said bridge, one or more displays coupled to said one or more graphics systems, and one or more peripheral devices coupled to said bridge.

20. The computing system of claim 19, wherein said processor comprises a Graphics Processing Unit (GPU).

21. The computing system of claim 18, wherein said one or more memory devices comprise one or more of: Dynamic Random Access Memory (DRAM), Synchronous Dynamic Random Access Memory (SDRAM), and/or Dual Data Rate memory (DDR), (DDRII).

22. The computing system of claim 18, wherein said one or more busses comprise address busses.

23. The computing system of claim 18, wherein said memory controller further comprises one or more inverters, one or more multiplexers and one or more flip-flops.

24. The computing system of claim 18, wherein said one or more inverters, one OF more multiplexers and one or more flip-flops are configured to, in operation:
modify the data transmitted along the at least one redundant data path by altering, switching, and/or toggling at least a portion of said data, and provide at least a portion of said altered, switched, and/or toggled data to at least one of said one or more memory devices.

25. The computing system of claim 24, wherein at least one of said altering, switching, and/or toggling further comprises inverting at least a portion of said data by at least one of said inverters.

26. The computing system of claim 24, wherein at least one of said altering, switching, and/or toggling further comprises substituting at least a portion of said data with an electrical zero, wherein said substituting is substantially performed by at least one of said multiplexers.

27. The computing system of claim 24, wherein modifying the data comprises transmitting substantially the same data transmitted during a previous transmitting operation.
